(19) United States
(12) Patent Application Publication
(10) Pub. No.: US 2025/0305915 A1
(43) Pub. Date: Oct. 2, 2025

(54) Method to Isolate Lipid Droplet Bound and Unbound Mitochondria from Liver

(71) Applicant: University of Cincinnati, Cincinnati, OH (US)

(72) Inventors: Karthickeyan Chella Krishnan, Mason, OH (US); Ushodaya Mattam, Cincinnati, OH (US)

(73) Assignee: University of Cincinnati, Cincinnati, OH (US)

(21) Appl. No.: 19/091,953

(22) Filed: Mar. 27, 2025

Related U.S. Application Data
(60) Provisional application No. 63/570,770, filed on Mar. 27, 2024.
(60) Provisional application No. 63/715,165, filed on Nov. 1, 2024.

(51) Int. Cl. G01N 1/34; G01N 1/28

(52) U.S. Cl. CPC G01N 1/34; G01N 1/286; G01N 2001/2866

(57) ABSTRACT

A method of isolating multiple mitochondria samples from liver is provided. The separation method isolates PDM from healthy, steatotic or fibrotic livers and enables the characterization of their importance in healthy vs. disease progression. Briefly, after low-speed centrifugation, the fat layer is first separated by overlaying with low sucrose buffer (MSHE) to bring the floating fat layer to the top. Next, the fat layer is collected to isolate PDM, while the supernatant is used to isolate CM.

### CROSS-REFERENCE TO RELATED APPLICATIONS

This application claims priority to U.S. Provisional Application Ser. No. 63/570,770, filed Mar. 27, 2024, and U.S. Provisional Application Ser. No. 63/715,165, filed Nov. 1, 2024, which applications are hereby incorporated by reference in their entirety.

### STATEMENT REGARDING FEDERALLY FUNDED RESEARCH OR DEVELOPMENT

This invention was made with government support under DK120875 awarded by National Institutes of Health. The government has certain rights in the invention.

### TECHNICAL FIELD

The present invention relates to mitochondria isolation techniques.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Isolated mitochondria are useful to study fundamental processes including mitochondrial respiration, metabolic activity, protein import, membrane fusion, protein complex assembly, as well as interactions of mitochondria with the cytoskeleton, nuclear encoded mRNAs, and other organelles. Liver is a convenient source for functional intact mitochondria for a number of reasons. Animal tissue is more readily homogenized than plant tissue because there are no cell walls, and liver in particular is a soft and fairly homogeneous tissue. The metabolism of endotherms requires that some tissues maintain a high density of mitochondria, so the potential yield is high. Isolating mitochondria from highly structured animal tissues such as muscle can be technically difficult since a high proportion of the organelles remain trapped in cell and tissue fragments (although muscle can be a good source). However, a substantial quantity of liver mitochondria can be obtained with a relatively short amount of preparation time.

Most methods to isolate mitochondria rely on differential centrifugation, a two-step centrifugation carried out at low speed to remove intact cells, cell debris, tissue debris, and nuclei from whole cell extracts followed by high speed centrifugation to concentrate mitochondria and separate them from other organelles. However, methods to disrupt cells and tissue vary in effectiveness. Improved methods to isolate mitochondria from liver are still needed.

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

In one aspect of the present invention, a method of isolating multiple mitochondria samples from liver is provided. The method involves:
a. homogenizing a liver sample to produce homogenized liver;
b. centrifuging the homogenized liver;
c. adding cold layering buffer to the centrifuged homogenized liver, resulting in a floating fat layer and a remaining homogenate layer;
d. collecting the floating fat layer and adding low sucrose homogenization buffer to the floating fat layer;
e. collecting a sample from the remaining homogenate layer and adding homogenization buffer to the remaining homogenate layer sample;
f. centrifuging the floating fat layer at a low speed; removing any pellet formed after centrifugation and repeating centrifugation;
g. centrifuging the remaining homogenate layer sample a low speed; removing any pellet formed after centrifugation and repeating centrifugation;
h. extracting a centrifuged homogenate layer sample from the remaining homogenate layer sample; wherein the centrifuged homogenate layer sample is taken from the center of the remaining homogenate layer sample;
i. performing centrifugation of the floating fat layer at a high speed to produce a peri-droplet mitochondria (PDM) pellet; and
j. performing centrifugation of the centrifuged homogenate layer sample at a high speed to produce a cytosolic mitochondria (CM) pellet.

In one embodiment, the homogenization step involves:
a. extracting and washing a liver sample;
b. transferring the sample to a homogenization buffer;
c. mincing the sample finely, producing a minced sample;
d. transferring the minced sample to a tissue grinder and adding additional homogenization buffer;
e. grinding the minced sample to produce homogenized liver.

In another embodiment, the low sucrose buffer is Mannitol-Sucrose-HEPES-EGTA (MSHE). In one embodiment, the homogenization buffer is Sucrose-HEPES-EGTA (SHE). In another embodiment, the high speed centrifugation is about 10 times faster than the low speed centrifugation. In one embodiment, the low speed centrifugation is about 900×g. In another embodiment, the high speed centrifugation is about 9000×g. In one embodiment, the liver sample is washed with phosphate buffered saline (PBS).

In another embodiment, the method further includes the steps of:
k. resuspending the PDM pellet in homogenization buffer;
l. performing centrifugation of the resuspended PDM pellet at a high speed to produce a washed PDM pellet;
m. resuspending the washed PDM pellet in assay buffer;
n. resuspending the CM pellet in homogenization buffer;
o. performing centrifugation of the resuspended CM pellet at a high speed to produce a washed CM pellet; and
p. resuspending the washed CM pellet in assay buffer.

In one embodiment, the assay buffer is mitochondria assay solution (MAS).

### BRIEF DESCRIPTION OF THE DRAWINGS

The foregoing summary, as well as the following detailed description of preferred embodiments of the application, will be better understood when read in conjunction with the appended drawings.

FIG. 1 is a series of images showing the isolation procedure for homogenized liver.

FIG. 2 is a series of images showing liver histology in mice liver.

FIG. 3 is a series of images showing LD-mitochondria association in mice liver.

FIGS. 4A-4C are a series of graphs showing altered CM and PDM levels in CDAA fed mice liver.

FIG. 5 is a graph showing high CS activity in PDM vs CM.

FIGS. 6A-6D are a series of images where PDM showed higher levels of OXPHOS protein complexes compared to CM.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

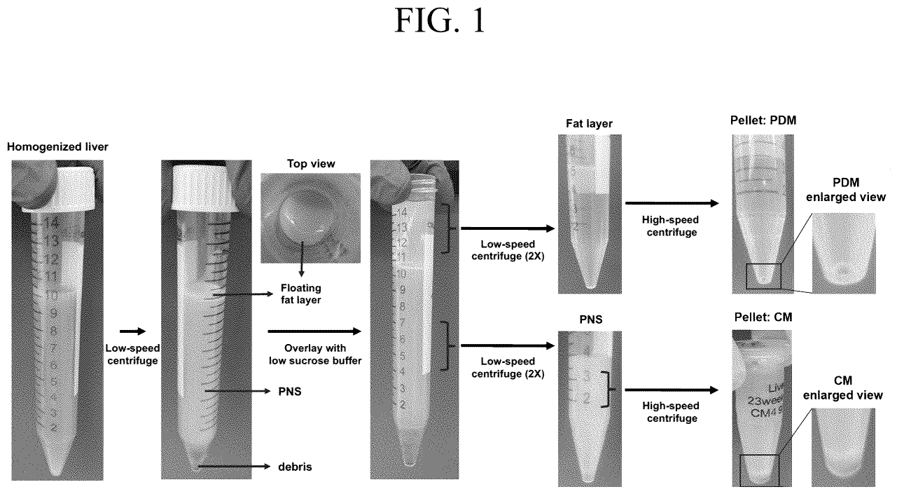

The present invention involves a novel method of isolating mitochondria from liver. In lipogenic tissues such as adipose, initial low-speed centrifugation reveals an intact floating fat cake, facilitating the straightforward separation of peri-droplet mitochondria (PDM, lipid droplet bound mitochondria) and cytosolic mitochondria (CM, unbound mitochondria). However, one of the major obstacles in isolating liver PDM is that the low-speed centrifugation generates a thin floating fat layer (as opposed to a fat cake in adipose) that can be very difficult to separate. To circumvent this problem, the present invention uses a new separation method based on differences in sucrose gradients (described herein and shown in FIG. 1) to isolate PDM from healthy, steatotic or fibrotic livers and to characterize their importance in healthy vs. disease progression. Briefly, after low-speed centrifugation, the fat layer is first separated by overlaying with low sucrose buffer (Mannitol-Sucrose-HEPES-EGTA “MSHE”) to bring the floating fat layer to the top. Next, the fat layer is collected to isolate PDM, while the supernatant is used to isolate CM.

As an example of the method of the present invention, samples were prepared as follows:

### Homogenization

1. Liver was extracted and washed in ice cold 1× phosphate buffered saline (PBS) to remove blood contamination.
2. Liver was then transferred to 4 mL homogenization buffer (Sucrose-HEPES-EGTA “SHE”) and minced finely.
3. Minced liver was then transferred into Potter-Elvehjem Tissue Grinders, and the volume was made up to 10 mL with homogenization buffer (SHE).
4. Minced liver was homogenized with 15 up and down strokes and the homogenate was collected into 15 mL tube.

### Isolation

1. Centrifuge homogenized liver at 900×g for 10 min at 4° C. (low-speed centrifuge).
2. Post centrifugation, floating fat layer will be visible.
3. Slowly add 4 mL of ice-cold layering buffer (MSHE) to the homogenate. Observe visible separation between the homogenate and floating fat layer. This allows us to collect pure form of floating fat layer and avoids contamination of fat layer with homogenate.
4. First, collect 3 mL of floating fat layer into a new 15 mL tube without disturbing homogenate and add 1 mL of homogenization buffer (SHE). After collecting the fat layer, collect 3 mL of homogenate from the middle of the tube into a new 15 mL tube and add 1 mL of homogenization buffer (SHE). Centrifuge both fat layer and homogenate tubes at 900×g for 10 min at 4° C. (low-speed centrifuge). Remove any pellet formed after centrifugation. Repeat the centrifugation step.
5. Use the entire contents of the fat layer tube for the next step. From the homogenate tube, collect 1.5 mL from the middle of the tube by avoiding any leftover fat layer into a 1.5 mL tube. Perform high speed centrifugation at 9000×g for 10 min at 4° C. for both fat layer and homogenate to pellet down peri-droplet mitochondria (PDM, lipid droplet bound mitochondria) and cytosolic mitochondria (CM, unbound mitochondria), respectively.

### Washing and Estimation

1 Perform the washing steps by resuspending the PDM in 200 μL and CM in 1 mL of homogenization buffer (SHE). Pellet down the mitochondria by centrifugation at 10000×g for 10 min at 4° C. (high-speed centrifuge). Repeat the washing step by resuspending the PDM in 200 μL and CM in 1 mL of homogenization buffer without BSA. Pellet down the mitochondria by centrifugation at 10000×g for 10 min at 4° C. (high-speed centrifuge).
2 Final resuspension of mitochondria is done in assay buffer (MAS). For PDM, the volume of MAS buffer depends on the pellet size (ranging from 50 μL to 500 μL). For CM, 500 μL of MAS buffer is used for resuspension.
3 Protein estimation is done by BCA method and mitochondrial estimation is by MTDR fluorescence.

TABLE 1
Homogenization buffer (SHE) composition

| Reagent | Concentration |
|---|---|
| Sucrose | 250 mM |
| HEPES | 5 mM |
| EGTA | 2 mM |

TABLE 2
Layering buffer (MSHE) composition

| Reagent | Concentration |
|---|---|
| Mannitol | 210 mM |
| Sucrose | 70 mM |
| HEPES | 5 mM |
| EGTA | 1 mM |

TABLE 3
Assay buffer (MAS) composition

| Reagent | Concentration |
|---|---|
| Mannitol | 220 mM |
| Sucrose | 70 mM |
| HEPES | 2 mM |
| EGTA | 1 mM |
| Potassium Monophosphate (KH₂PO₄) | 10 mM |
| Magnesium Chloride (MgCl₂) | 5 mM |

### Examples of Use of Mitochondria Isolated Using the Present Method

Currently, there is limited evidence on the role of lipid droplet associated, peridroplet mitochondria (LDM or PDM) in healthy liver metabolism both during fed and overnight fasted conditions. Nevertheless, the role of PDM function in diseased liver such as during steatohepatitis (MASH) progression remains unknown. The present invention used a novel method to isolate both PDM and cytoplasmic mitochondria (CM) from a mouse model of diet-induced MASLD/MASH to characterize their relative function during simple steatosis to advanced MASH progression. As a healthy control, both PDM and CM were isolated from chow-fed mice. In all our conditions, the mice were fasted for four hours before euthanasia.

Our studies show that while the CM content remains almost the same, the PDM content decreases from simple steatosis to advanced MASH. We next found that, compared to CM, PDM are bioenergetically active with higher pyruvate oxidation capacity in both healthy and diseased liver. Additionally, we found that higher respiration capacity of PDM was associated with higher levels of OXPHOS protein complexes as well as higher TCA cycle flux as measured by citrate synthase activity. On the contrary, PDM had higher fatty acid oxidation capacity in both healthy and early steatotic liver, which declined with MASH progression. Current and future experiments include transmission electron microscopy (TEM) of the liver and proteomics of the two mitochondrial populations isolated from different stages of the disease. Altogether, the high degree of differences between PDM and CM population during MASH progression highlights their distinct role in disease progression towards MASH.

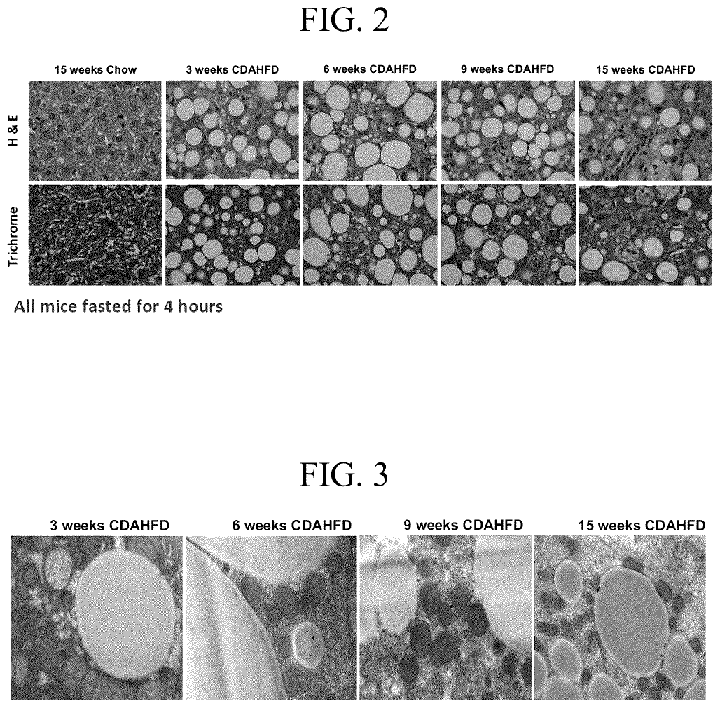

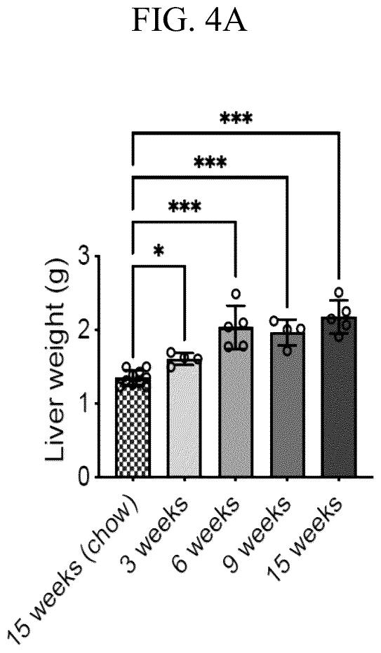

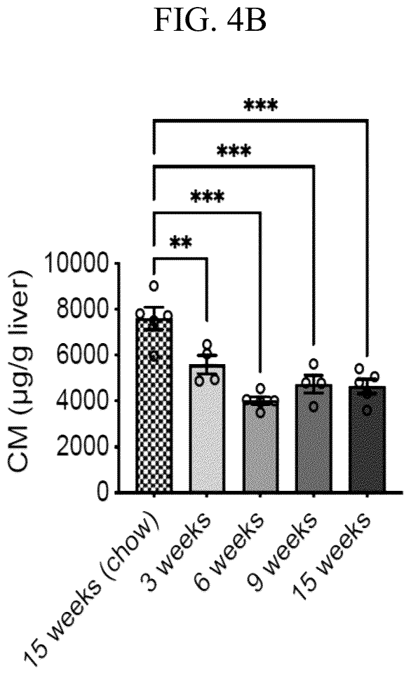

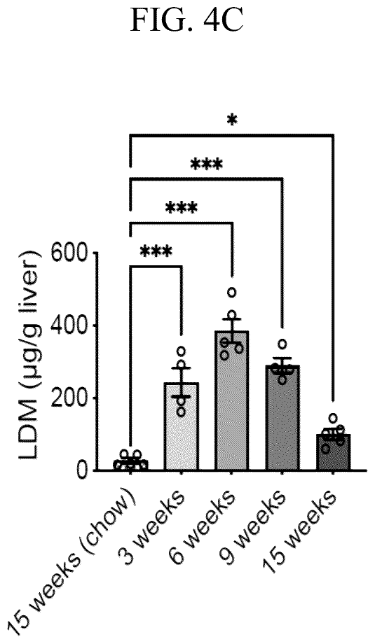

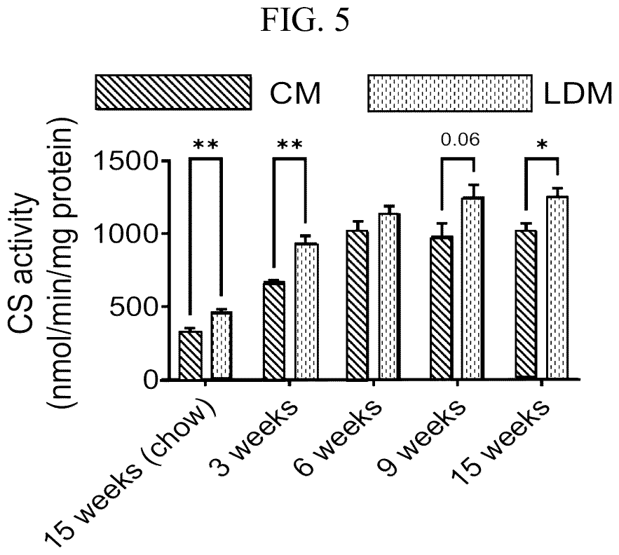

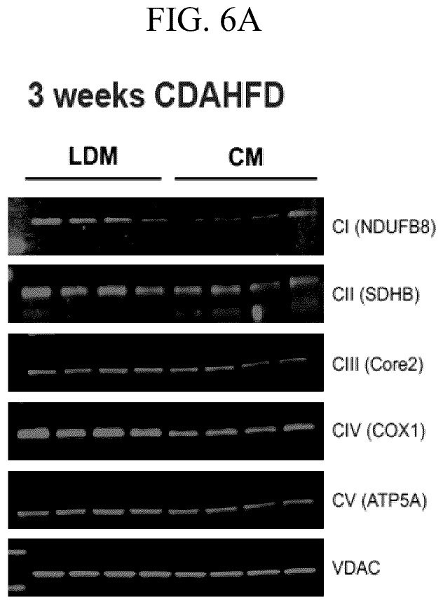

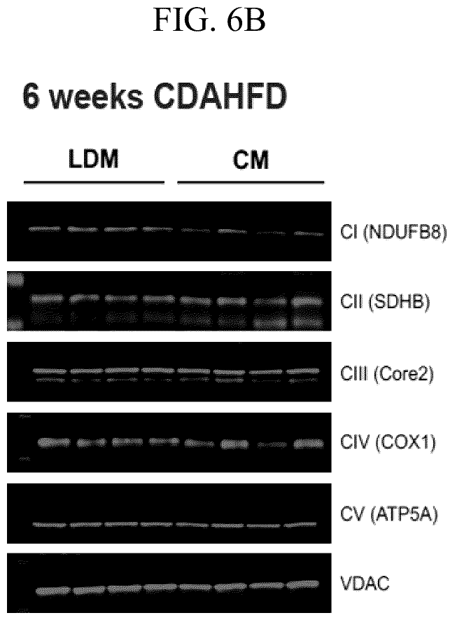

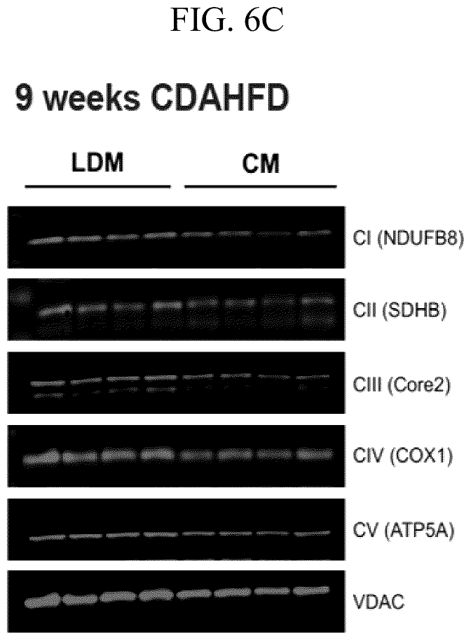

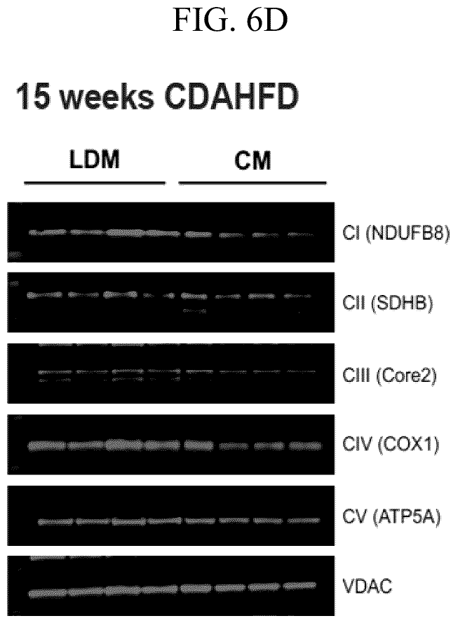

The results reported in FIGS. 2-6 showed:
1. Enhanced PDM population observed in early steatosis and decreased in advanced MASH.
2. PDM is bioenergetically active (Pyruvate oxidation and bioenergetics) compared to CM in chow fed and CDAHFD mice liver.
3. PDM showed enhanced FAO compared to CM in chow fed animals, early steatosis and compromised in MASH.

Although not described in detail herein, other steps which are readily interpreted from or incorporated along with the disclosed embodiments shall be included as part of the invention. The embodiments that have been described herein provide specific examples to portray inventive elements, but will not necessarily cover all possible embodiments commonly known to those skilled in the art.

What is claimed is:

1. A method of isolating multiple mitochondria samples from liver, the method comprising:
a. homogenizing a liver sample to produce homogenized liver;
b. centrifuging the homogenized liver;
c. adding cold layering buffer to the centrifuged homogenized liver, resulting in a floating fat layer and a remaining homogenate layer;
d. collecting the floating fat layer and adding low sucrose homogenization buffer to the floating fat layer;
e. collecting a sample from the remaining homogenate layer and adding homogenization buffer to the remaining homogenate layer sample;
f. centrifuging the floating fat layer at a low speed; removing any pellet formed after centrifugation and repeating centrifugation;
g. centrifuging the remaining homogenate layer sample a low speed; removing any pellet formed after centrifugation and repeating centrifugation;
h. extracting a centrifuged homogenate layer sample from the remaining homogenate layer sample; wherein the centrifuged homogenate layer sample is taken from the center of the remaining homogenate layer sample;
i. performing centrifugation of the floating fat layer at a high speed to produce a peri-droplet mitochondria (PDM) pellet; and
j. performing centrifugation of the centrifuged homogenate layer sample at a high speed to produce a cytosolic mitochondria (CM) pellet.

2. The method of claim 1 where in the homogenization step comprises:
a. extracting and washing a liver sample;
b. transferring the sample to a homogenization buffer;
c. mincing the sample finely, producing a minced sample;
d. transferring the minced sample to a tissue grinder and adding additional homogenization buffer; and
e. grinding the minced sample to produce homogenized liver.

3. The method of claim 1 wherein the low sucrose buffer is Mannitol-Sucrose-HEPES-EGTA (MSHE).

4. The method of claim 1 wherein the homogenization buffer is Sucrose-HEPES-EGTA (SHE).

5. The method of claim 1 wherein the high speed centrifugation is about 10 times faster than the low speed centrifugation.

6. The method of claim 1 wherein the low speed centrifugation is about 900×g.

7. The method of claim 1 wherein the high speed centrifugation is about 9000×g.

8. The method of claim 2 wherein the liver sample is washed with phosphate buffered saline (PBS).

9. The method of claim 1 further comprising the steps of:
k. resuspending the PDM pellet in homogenization buffer;
l. performing centrifugation of the resuspended PDM pellet at a high speed to produce a washed PDM pellet;
m. resuspending the washed PDM pellet in assay buffer;
n. resuspending the CM pellet in homogenization buffer;
o. performing centrifugation of the resuspended CM pellet at a high speed to produce a washed CM pellet; and
p. resuspending the washed CM pellet in assay buffer.

10. The method of claim 9 wherein the assay buffer is mitochondria assay solution (MAS).
